(19) United States
(12) Patent Application Publication
(10) Pub. No.: US 2014/0311216 A1
(43) Pub. Date: Oct. 23, 2014

(54) METHOD FOR DETERMINING THE PARTICLE COUNT IN THE EXHAUST GAS OF INTERNAL COMBUSTION ENGINES

(71) Applicants: Erich Schiefer, Selzthal (AT); Alexander Bergmann, Graz (AT)

(72) Inventors: Erich Schiefer, Selzthal (AT); Alexander Bergmann, Graz (AT)

(73) Assignee: AVL LIST GMBH, Graz (AT)

(21) Appl. No.: 14/233,295

(22) PCT Filed: May 31, 2012
(86) PCT No.: PCT/EP2012/060306

§ 371 Date: Mar. 25, 2014

(30) Foreign Application Priority Data
Jul. 18, 2011 (AT) A 1056/2011

(51) Int. Cl. G01N 15/06; G01M 15/10

(52) U.S. Cl. CPC G01N 15/06; G01M 15/102
USPC 73/23.31

(57) ABSTRACT

A method for detecting the number of particles in the exhaust gas of combustion engines, wherein a value that is characteristic for the quantity of the particles is determined, for example, in form of the blackening of a filter or determination of the concentration, wherein, furthermore, the suction time and/or the suction volume of the exhaust gas are measured, and wherein, if necessary, the blackening rate is calculated, based on the characteristic value and the suction time and/or the suction volume by way of a first conversion function, wherein the number of particles is determined based on the characteristic value, the suction time and/or the suction volume as well as the data of the first conversion function by way of a second conversion function.

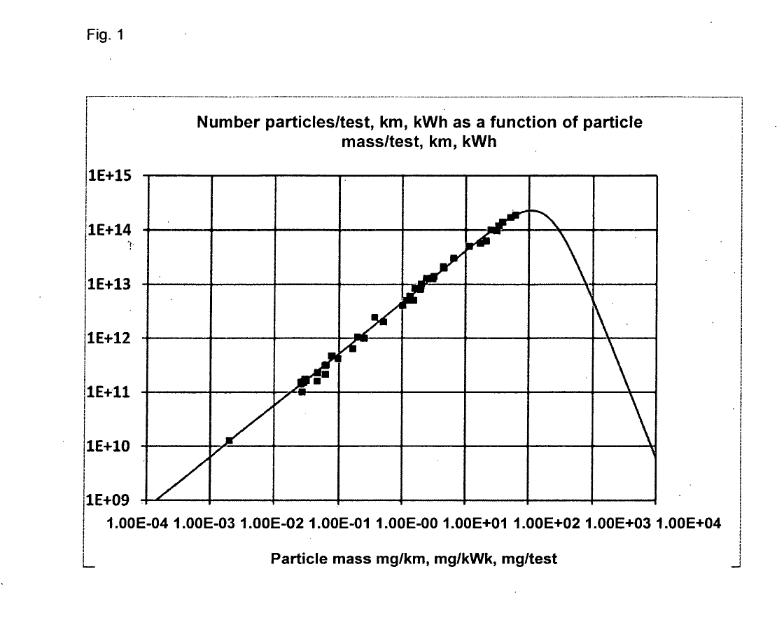

To allow for further advancing the possibilities for analysis with information regarding the number of particles, the pressure ratios at the filter are determined as well, and whereby the mean particle diameter is determined, based on this and a third conversion function, as well as the quantity of particles, and the number of particles is established based on the characteristic value, the suction time and/or the suction volume, the data of the first conversion function and the determined mean particle diameter, relying therein on various intermediate computing processes and conversion functions, all of which can, however, be combined into a common fourth function, and wherein the number of particles is detected by way of this fourth conversion function.

The invention relates to a method for detecting the number of particles in the exhaust gas of combustion engines, wherein a characteristic value is determined for the quantity of particles, for example in form of the blackening of a filter or determination of the concentration, wherein the suction time and/or the suction volume of the exhaust gas is also measured, and wherein, if necessary, the blackening number is calculated based on the characteristic value and the suction time and/or the suction volume by way of a first conversion function, and wherein the particle number is established based on the characteristic value, the suction time and/or the suction volume and the data of the first conversion function by way of a second conversion function.

Such methods are applied in measuring instruments for measuring soot particulates, mainly, but not exclusively, for measuring soot particulate emissions from explosive prime movers. Aside from the blackening number (filter smoke number, FSN), it is also possible to arrive at a concentration value in mg/m³. In addition, as described in AT 6349 U1, it is further possible to determine the mean particle diameter that is then provided for further calculations.

DE 102006024089 A1 discloses a method for determining the load state of a soot particulate filter in the exhaust train. A reference component is measured in addition to the pressure loss on the particulate filter, and first and second calibration functions are created. DE 102006041478 A1, in turn, discloses a method for detecting the soot concentration in the exhaust gas of a combustion engine that contains an accumulating particulate sensor for determining the soot concentration, and the sensor signal is equalized by predetermined corrections, such as, for example, temperature.

It is the object of the present invention to improve the options for analysis of a method as described in the introduction.

To achieve this object, the invention is characterized in that it additionally provides for detecting the pressure ratios at the filter, whereby, based on this as well as the quantity of particles, the mean particle diameter is determined by way of a third conversion function, and whereby the number of particles is established based on the characteristic value, the suction time and/or the suction volume, the data of the first conversion function and the determined mean particle diameter, therein relying on various intermediate computing processes and conversion functions, all of which can, however, be combined into a common fourth function, and wherein the number of particles is detected by way of this fourth conversion function.

For typical particle emission relationships, the half-width of the distribution function of the particle sizes around the mean particle diameter can be described more or less exactly by a constant factor of the mean particle diameter. Using these data, based on the blackening of the filter paper, the measured mean diameter and the value for the half-width of the particle distribution, it is thus also possible to estimate and/or calculate a value for the number of particles, which can be used either for arriving at a more precise result of the calculation of the particle number or can be output as a stand-alone measured value and/or estimated value. It was found that there exists a correlation between the number of particles and the concentration of particles, particularly when the measurements relate to the total emissions of solid particles, specifically the carbon fraction of the exhaust gas particulates. This applies specifically, nonetheless or specifically, also when the dwelling time of the particles from the time of their “generation” until the time, when the measurement of the concentration and of the number of particles is taken, is in the range of ca. 1 sec or greater (but at least >0.1 sec). Due to the fact that many instruments for measuring soot particulates obtain the measured value (FSN or mg/m³) integrally via the residue and agglomeration of particles on filter paper, this means that the “dwelling time” of the particles, seen from the agglomeration perspective, must always be viewed as much greater an “ca. 1 sec.” This applies particularly, when the measured values are integrated over one or several measurements and an analysis of the sum of the measured values is done.

A measurement of this kind can be conducted such that, for example, the values measured by the various test points for paper blackening as well as the associated measuring time are weighted and added up using diverse cycle data, and the total integral is output as a “cycle-”relevant measured value in mg/test and/or number/test. The summation of the paper blackening therein must be done via the detour of “concentration values,” since the relationship is non-linear. Alternately, it is possible to achieve the “summation of the values” by means of the area concentration in mg/m², that can be calculated based on the blackening of the paper or by means of the volume concentration in mg/m³ alone. The relationship x/test means that the reference value can be mg alone, or mg/m³ exhaust gas, or mg/performance, or mg/km or mg/mile . . . and the equivalent “number of particles”/test . . . .

According to an advantageous variant of the invention, by way of advancing said method, the selected suction time is at least 0.1 seconds, preferably at least 1 second.

According to a further embodiment of the present invention, it is provided that the half-width of the distribution function of the particle sizes around this mean particle diameter is determined based on the established mean particle diameter and a constant factor, and that the number of particles is determined based on the characteristic value, the established mean diameter and the value for the half-width.

A further embodiment of the invention is characterized in that a plurality of measurements is taken in succession, that the detected particle quantities are added up and/or integrated, weighted according to suction times, suction volumes and/or suction lengths, and that the integral number of particles is determined based on these weighted added up values.

Advantageously, a total test volume is determined in addition to the indicated characteristics, the volume flows, which are proportional in relation to the predetermined weighting factors, are accumulated and used for a determination of the quantity and number of particles, and the integral quantity and number of particles are determined taking into consideration the relationship between the respective suction volume and the total test volume, wherein the volume flow of the exhaust gas, that is aspirated through the filter paper of the measuring instrument, is preferably adjusted and controlled proportionally in relation to the weighting factor, and whereby the exhaust gas quantity that corresponds to the weighting factor is sucked through the filter paper.

According to a further optional characteristic of the invention, it is provided that a plurality of measurements is taken in succession and that the quantity and number of the particles are determined for each measurement, and that a mean value as well as the associated imprecision and/or uncertainty of the measured value is/are calculated.

A further variant of the invention is characterized in that the exhaust gas temperature at the sampling point and/or the mean dwelling time of the exhaust gas from the point of the generation of the particles to the point, when the sample is taken, are made part of the calculation. It has been found, that the temperature of the exhaust gas at the sampling point can be used to improve and optimize the correlation between the number of particles and the concentration measurement from the FSN values.

According to a further embodiment of the method according to the invention, it is provided that the second conversion function characterizes, in a dual-logarithmic presentation and in the range of very few up to ca. 10¹⁴ particles per test, a linear relationship between particle mass and particle number, then transitioning to an inverse function with a further increase of the number of particles.

Preferably, it can be provided therein that the second conversion function has a peak, when the number is ca. 2 to 5×10¹⁴ particles per test.

The invention will be illustrated in further detail below, based on embodiments and concrete applications. The FIGURE that contains the drawing shows the relationship between the particle mass/test, particle mass/kWh, particle mass/km and the number of solid particles /test, /km or /kWh.

A preferred application of the method according to the invention envisions measuring and estimating the number of particles in the exhaust gas of combustion engines, particularly of diesel engines. The measurement is taken, for example, by a conventional smoke meter, inside which there usually reside a conversion function for paper blackening and suction time and/or suction volume to FSN and/or concentration values, as described, for example, in EP 0 357 668.

The particle number calculation is done with the aid of a function that can be presented, for example, in the manner of Y=1/(A+B/x), wherein x presently represents the concentration of the particles mg/m³, and Y is the number of particles/m³. Functions of this type are usually valid in certain concentration ranges. The concentration can be measured with a smoke meter, as indicated previously, or by any other method, for example gravimetrically with filter measurement and weighing. Sample volume is determined with a smoke meter and sucked through filter paper. The soot-loaded filter paper is then illuminated, and the filter load is determined by measuring the reflected light.

The measured soot-particle-concentration Pk of the accumulated particles is expressed in μg/m³ on filter paper and can be calculated by a formula

Pk=Konz*1000 in μg/m³ (1),

wherein Konz=concentration of particles in mg/m³. The value Konz (in mg/m³) in formula 1 is calculated therein, for example, according to the formalistic guidelines from the handbook for the smoke meter AT1240D, rev 7, May 2007, chapter 13.5 or the periodical Motortechnische Zeitschrift 54, pages 16-22, 1993, based on the soot number FSN, or directly.

Advancing this process further, based on a further allocated function, it is possible to determine, based on the paper blackening, suction time and/or suction volume and the data of the first function, also the number of particles; this is based on the fact that the smoke meter is also used implicitly for determining the mean diameter of the particles and that particle emissions within certain bandwidths satisfy logarithmic-normal distributions. The sum of the mass of all particles within this distribution is once again presented by the value x, as seen from the above formula. Assuming either a fixed half-width of the distribution function, together with the value for x, there is only one solution, where the mass of the sum of individual particles results, for the assumed distribution with a given mean diameter (in the diagram at 50 nm), in the mass x.

Depending on the origin of the particle type (for example, soot in the exhaust gas of a diesel or gasoline engine, in heavy oil, etc.), the half-width of the particle number distribution is a function of the mean particle diameter, or also a more or less constant value of an order of magnitude. Ultimately, the different methods are implemented, evaluated in conjunction, and a mean number of particles is calculated by way of a total function offering better exactness and reliability.

To improve the precision, it is also possible to determine the particle size, preferably as a mean particle diameter (Dmm), as disclosed, for example, in AT 6349 U1, and as an additional parameter for the calculation of the particle number, which can be considered for the calculation in order to further improve the usefulness of having the temperature value for the exhaust gas at the sampling point.

To this end, the measuring instrument itself can be adjusted such that the measurement is taken fully automatically, until a predefined differential pressure is present on the measuring filter. When 100 mbar is selected as differential pressure, using the relationships as represented in AT 6349 U1, it is possible, for example, to calculate the associated mean particle diameter. The remaining characteristic values, such as filter load, paper blackening, suction volume, etc., and the calculation with regard to the concentration and/or FSN, can be established at this point according to the existing standards.

Assuming the use of a value of 100 mbar as threshold value for the negative pressure, when the measurement is interrupted, the values/data are stored, and the following functional relationship would result:

Dmm=1.1246×10⁻⁰³ x²+2.1428×10⁻⁰¹x+4.0815×10⁺⁰¹, (2)

with x=the surface load of the filter paper in mg/m².

The function parameters can vary correspondingly, depending on the setup and the used filter paper, as well as the defined differential pressure on the filter paper.

A further parameter for rendering the result even more meaningful that can be incorporated in the method, is the mean dwelling time of the exhaust gas from the location of where it is generated, for example the discharge valves of an engine, to the point where the sample is taken for the purpose of counting the particles (FSN and additional function). This dwelling time therein can be calculated from the muffler volume and the mass flow of the exhaust gas, or also from muffler volume, stroke volume, speed, pressure and temperature in the muffler pipe, or also by other equivalent methods, wherein the values can be either input or estimated, or measured.

If necessary, carrying out a plurality of measurements in succession is also possible. In this case, the measured values for HP and suction volume (or suction time) are used for the calculation of the respective concentrations per m³ and added (and/or integrated) in a weighted fashion according to the respective suction times (or volumes and/or suction lengths). Based on these weighted added up values, it is then possible to arrive at a calculation of an integral concentration in mg/m³ or the particle number N expressed as N/m³. Alternately, it would be possible to calculate a mean value and the associated imprecision and/or uncertainty of the measured value on the basis of a plurality of measurements, as well as indicate the “course over time within a measurement series” from individual measured values. It is advantageous in both cases for a plurality of measured values of HP and suction volume (suction time) to be temporarily stored and integrated/added up and integrally analyzed, on the one hand, and/or to calculate a concentration in mg/m³ or the particle number N/m³ also from the individual measured values for HP and suction volume, on the other hand. Using the data related to HP and suction volume (suction times), it is also possible to calculate an integral total value of the concentration and/or the particle number that can be assigned a measurement uncertainty resulting, on the one hand, from the measuring instrument, internal zero stability, and imprecision of the measured value, on the other hand.

Moreover, it is possible to obtain, in addition, a dynamic course of measured values during the test process that is able to provide information regarding time-related variations; the “dynamic or quasi-dynamic” precision thereof must satisfy, on the one hand, the statistics of the individual measurements and, in addition, also the internal measured value reproducibility of the integral measured value, whereby the total precision must therefore satisfy all previously named requirements, which allows for achieving a further improvement in terms of the reproducibility of the measured values.

It is possible to use a variant of the method also for measuring the number of particles in the exhaust gas of combustion engines, in the context of emission cycles. This variant envisions that the paper blackening values that are taken at different test points, as well as the associated measuring times, are temporarily stored. Subsequently, the conversion function for paper blackening and suction time and/or suction volume that resides in the smoke meter is applied to the FSN values in order to calculate the concentration of the individual points based on these measured data from paper blackening and measurement times (suction time and/or suction volume). These values can then be integrated in a time-weighted fashion (or summed up in an equivalent manner), based on data of preset stationary or dynamic cycles. This way, it is possible, for example, to establish a cycle-integrated measured value in mg particle/test or FSN/test, or it is possible to calculate the particle number/test, using the previous further conversion function as provided in the basic embodiment, from paper blackening, suction time and/or suction volume, as well from the FSN or mg/test data.

It is possible therein to accumulate the measured particle values of a plurality of different test points on a single filter paper, wherein there exists the possibility of selecting the duration of the “accumulating” action of the particles on the filter paper, with each individual measured value selected proportionally in relation to the weighting factor of a defined measuring cycle. To avoid the necessity of a paper feed while accumulating the particles, the accumulating action can be operated by the on/off control on the pump that is used in the device. An interruption and paper feed in this test mode is only envisioned in cases when this is required for reasons of metrological accuracy.

In this method variant, the suction length is calculated based on all volumes that result for the accumulation of particles on the filter, the integrally resulting sum of paper blackening instances is used in the calculation of further data. For example, it is possible to calculate, based on the paper blackening and the suction length, the integral mass load that is then used further to establish a particle number, as explained above. It is possible therein to use the previously discussed additional values in order to improve the results. The weighting factors can be user-selected parameter or legally prescribed, based on stationary or even dynamic test cycles.

In the event of a dense load on the filter, when the measurement must be aborted prematurely, the measured volume values and the associated paper blackening instances, as well as any other data are preferably temporarily stored. After a paper feed without rinsing the sampling lines, the further parts of the cycle continue to be accumulated in a weighted fashion. If necessary, it is possible for still further paper feeds to be implemented, including a temporary storage of the data. As early as while the measurements are still being taken, or not until the end of the test/measuring cycle, the individual results are converted, together with the suction length or the suction volume, from the paper blackening to mg/m³. It is possible therein to arrive at a mass determination, weighted and integrated correspondingly relative to the integral individual suction volumes. Finally, based on the data, it is possible to arrive at an output for the cycle emission in mg(mass)/test and/or, as explained above, in number of particles/test.

The particles on the filter are advantageously accumulated by means of a speed-controlled pump that pulls the measuring gas over the filter, wherein it is this pump that adjusts the volume flow directly proportionally relative to the exhaust gas mass flow. The volume flow that is adjusted over the filter with the aid of the pump is preferably always related to the internal standardization value FSN and/or mg/m³ of 100 kPa and 25° C. (298° K). For stationary cycles, the weighting factor is either taken into account in the context of the final calculation, or it is alternately taken into account as a volume-proportional factor in relation thereto. A speed-controlled pump is preferably used for the measurement of dynamic traveling cycles.

As a matter of principle, these methods can also be used in the calculation of the number of particles from concentration values in general, when, made possible by the presently introduced measures, such as, for example, the particle size and/or by the temperature measurement of the measurement of the dwelling time, it is possible to obtain additional information. With very low emissions that are in the range of 1 μg/m³ soot particle fractions, when particle filters are in use, or that are in the range of 10¹¹ particles/m³, respectively, extended measuring times must be expected for the used measuring systems. To avoid this in as much as possible, many measuring instruments also offer the option of adding up the measured values from the paper blackening, as well as of the respectively measured volumes in order to then calculate the concentration, the FSN value and the particle number based on this integral value.

If necessary, it is alternately also possible to weight the individual values from the paper blackening and the measuring time (and/or measured volume) as measured at the individual test points and to thus simulate the measured values of a complete cycle, adding and/or integrating the respective values. This yields the possibility of calculating again one or several measured value(s) in mg/test or FSN/test or particle number/test.

Table 1 demonstrates a related example. Said table 1 shows, by way of an example, results for concentrations that can be calculated based on individual measurements taken during a test run, and the obtained measured values in the form of raw data for paper blackening and suction length, as well as the concentrations resulting therefrom. The weighting factor in table 1 has already been converted to m³ equivalent (weighting) dimensions.

In the shown example, the total in column 9 has the dimension mg/test the number N in column 9 calculated from this, the dimension number/test. Presently, it should be explicitly noted that this kind of the formal calculation in column 9 is also applicable, if the thus weighted sum yields values in mg/test, in mg/km, mg/kWh. Based on this, an equivalent calculation is possible based on the given formalisms, a number value in N/test, N/km or N/kWh.

Column 8 shows the values that result, when the particle numbers that are calculated based on the individual non-weighted concentrations are weighted, and the number/test is calculated from this. It should be noted in this context that this calculation is mathematically not completely exact, because the relationships between number and mass are not linear.

Column 10 shows the calculated result for the case that the sum of the particle number of the cycle is calculated based on weighted masses of individual test parts as concentration *weighting. The total result for N in column 10 is expectedly in the approximate range—but not completely equal—to the result for N in column 9 or also in column 8. Table 1a shows calculated results, using the total volume flow from Table 2 of 43.33 m³.

TABLE 1

| | 2 | 3 | | | 6 | | 8 | | 10 |
|---|---|---|---|---|---|---|---|---|---|
| | Blackening | Suction | 4 | 5 | Number | 7 | Number Ni | 9 | Number N from |
| 1 | of the | volume | Suction | Concentration | from | Weighting | weighted from | Weighted mass in | weighted |
| Measurement | paper PB | liters | length | mg/m³ | mg/m³ | in m³ | (6) | mg | concentration |
| 1 | 0.5 | 2 | 2.87 | 1.08 | 5.00 × 10¹² | 0.2 | 1.00 × 10¹² | 0.216 | 1.02 × 10¹² |
| 2 | 1 | 7 | 10.04 | 0.729 | 3.39 × 10¹² | 0.1 | 3.39 × 10¹¹ | 0.0729 | 3.46 × 10¹¹ |
| 3 | 0.07 | 10.5 | 15.05 | 0.025 | 1.17 × 10¹¹ | 0.3 | 3.50 × 10¹⁰ | 0.075 | 3.56 × 10¹¹ |
| 4 | 0.4 | 2 | 2.87 | 0.83 | 3.85 × 10¹² | 0.1 | 3.85 × 10¹¹ | 0.083 | 3.94 × 10¹¹ |
| 5 | 2 | 2.7 | 3.87 | 5.07 | 2.28 × 10¹³ | 0.05 | 1.14 × 10¹² | 0.2535 | 1.20 × 10¹² |
| 6 | 1 | 5 | 7.16 | 1.009 | 4.68 × 10¹² | 0.1 | 4.56 × 10¹¹ | 0.1009 | 4.79 × 10¹¹ |
| 7 | 0.3 | 1 | 1.43 | 1.22 | 5.65 × 10¹² | 0.15 | 8.47 × 10¹¹ | 0.183 | 8.68 × 10¹¹ |
| Σ | | | | | | Σ = 1 | Σ (Ni) = | Σ = 0.9838 | N = 4.67 × 10¹² |
| | | | | | | | N: 4.2 × 10¹² | N: 4.64 × 10¹² | |

TABLE Ia

| | | | | 6a | 10 |
|---|---|---|---|---|---|
| | | 8 | 9 | Number N | Number N |
| 1 | 7 | Weighting at | Weighted mass, | from table | from weighted |
| Measurement | Weighting | 43.33 m³ | in mg | (6a)^{*}44.33 | concentration |
| 1 | 0.2 | 8.67 | 9.36 | 4.33 × 10¹³ | 4.07 × 10¹³ |
| 2 | 0.1 | 4.33 | 3.16 | 1.47 × 10¹³ | 1.44 × 10¹³ |
| 3 | 0.3 | 13.00 | 0.32 | 1.52E+12 | 1.51E+12 |
| 4 | 0.1 | 4.33 | 3.60 | 1.67 × 10¹³ | 1.63 × 10¹³ |
| 5 | 0.05 | 2.17 | 10.98 | 4.94 × 10¹³ | 4.72 × 10¹³ |
| 6 | 0.1 | 4.33 | 4.37 | 1.98 × 10¹³ | 1.97 × 10¹³ |
| 7 | 0.15 | 6.50 | 7.93 | 3.67 × 10¹³ | 3.48 × 10¹³ |
| Σ | Σ = 1 | Σ = 43.33 | Σ = 39.72 | | |
| | | | N = 1.41 × 10¹⁴ | N = 1.82 × 10¹⁴ | N = 1.75 × 10¹⁴ |

Taking into consideration the different algorithms, it can be seen that, with the same measured results mg/m³ for the individual tests (column 5, table 1), regarding the individual values with the exhaust gas test volume of ca. 43 m³, the particle number is in the range of 1.4 to 1.82*10̂14 (1.6e14±15%) per test, while, with an exhaust gas test volume of 1 m³ (table 1), there results a bandwidth of results ranging from 4.2 to 4.7*10¹² particle/test.

For the calculation of the number/test from the concentration values in mg/m3 or mg/test of table 1 and 1a, the following function was used:

Number of particles/test=Y

Concentration of particles (in mg)/test=x

Y=1/(a+b/x)

with a=1.71×10̂−15; b=2.14×10̂−13, for concentration values in the range to 100 mg/test.

The variation bandwidth of the coefficient a is ca. ±20%, for b ca. ±5% of the indicated value.

For higher concentrations, it is also possible to alternately use the following function:

Y=(4*a/x′̂(c+1)*b′̂(c+1)*c²)/(c−1+c*x̂(−c)*b̂c+x̂(−c)*b̂c)²

With a=2.50E+14 b=100 c=2

for concentration values in the range from 0 to >2000 mg/test.

The indicated weighting factors always relate to the test-cycle part and contain the conveyed exhaust gas quantities and/or exhaust gas masses. The “sum of all weighting factors” is always standardized to 1. The following table 2 shows an example for such weighting calculations:

TABLE 2

| 1 | 2 | 4 | 5 | 6 | |
|---|---|---|---|---|---|
| Mea- | Mass | Cycle-weight- | Weighted | Weighted, | 7 |
| sure- | flow | ing factor | mass | volume flow | Weighting |
| ment | kg/h | in h | in kg | in m³ | factor |
| 1 | 20 | 0.3 | 6 | 5.13 | 0.12 |
| 2 | 70 | 0.15 | 10.5 | 8.98 | 0.21 |
| 3 | 105 | 0.05 | 5.25 | 4.49 | 0.10 |
| 4 | 40 | 0.1 | 4 | 3.42 | 0.08 |
| 5 | 120 | 0.1 | 12 | 1027 | 0.24 |
| 6 | 60 | 0.13 | 7.8 | 6.67 | 0.15 |
| 7 | 30 | 0.17 | 5.1 | 4.36 | 0.10 |
| Σ | | Σ = 1 | Σ = 50.65 | 43.33 | Σ = 1 |

The mass flow in kg/h is the mass flow of the engine that would result consequent to 1 hour of constant travel at this test point. The cycle-weighting factor is either individually selected or prescribed by legal requirements, standards or regulations. The value can be used as a time-proportional value.

The weighted mass of each test part=mass flow (in kg/h)*weighting factor (in h).

The weighted test volume results as follows: the weighted mass is converted to the density-standard value of the measurement instrument from 100 kPa and 25° C. (Mass in kg/density in kg/m³ results in m³ weighted test volume). The weighting factor in column 7 per se results here as weighted volume of the test in m³, divided by the sum of all weighted volumes from individual tests. The sum of all values is 1. The dimension is m³.

If the measurement of all particles is to be done on a single filter paper, and the measurements are taken at discrete stationary measuring points, two different options are available for the implementation. On the one hand, a total test volume, for example 20 liters, can be defined as the total suction volume, and the volume flows that are proportional to the weighting factors (for example, according to column 7, table 1 or 2) can be accumulated over the filter paper. As a result, the mass and number of particles are obtained, measured with the filter paper. Taking into account the relationship between the suction volume over the filter paper and the total exhaust gas volume over the test, the mg/test and/or the particle number/test is obtained.

In the examples as set forth above, the masses and numbers as shown, for example, in table 1, columns 9 and 10, would be related to a volume of 1 m³. If the total volume flow, as shown in table 2, is 43.33 m³, the correct weighting value, however, is the direct volume value as presented in table 2, column 6. Due to the fact that the relationship is not linear, a volume flow of the engine over the total cycle of 43.33 m³, and using the weighting factors in column 7 of table 1, the values that result are as depicted in table 1a. Alternately, the weighting can also be achieved in that the volume flow of the measuring gas over the filter paper is adjusted or controlled proportionally to the weighting factor, and whereby the quantity of exhaust gas that is proportionally corresponding to the weighting factor is aspirated over the filter paper.

If the dynamic traveling cycles are to be measured as well over the filter paper, only the last-described method can be selected, wherein, in this case, the volume flow over the filter paper is adjusted proportionally relative to the measured exhaust gas quantity. Preferably, the volume flow therein is to be adjusted via a signal that is proportional relative to the exhaust gas mass flow, using a controllable pump or a mass throughflow controller. The relationship between particle mass/test, particle mass/kWh, particle mass/km and the number of solid particles/test, /km or /kWh is shown by way of a diagram in the FIGURE that contains the drawing. The term particle, as presently used, only refers to “solid carbon” particles.

The preceding control methods can also use other reference values for temperature and pressure; however, in that case, it would be necessary to carry out non-linear conversions in order to arrive at a correct conversion of the parameters.

1. A method for detecting the number of particles in the exhaust gas of combustion engines, wherein a value that is characteristic for the quantity of the particles is determined, for example, in form of the blackening of a filter or the determination of the concentration, wherein, furthermore, the suction time and/or suction volume of the exhaust gas is/are measured, and wherein, if necessary, the blackening rate is calculated based on the characteristic value and the suction time and/or the suction volume by way of a first conversion function, wherein the number of particles is determined based on the characteristic value, the suction time and/or the suction volume as well as the data of the first conversion function by way of a second conversion function, wherein in addition, the pressure ratios at the filter are determined, and the mean particle diameter is determined based on this by way of a third conversion function and the quantity of particles, and the number of particles is established based on the characteristic value, the suction time and/or the suction volume, the data of the first conversion function and based on the determined mean particle diameter, relying therein on various intermediate computing processes and conversion functions, all of which can, however, be combined into a common fourth function, and wherein the number of particles is detected by way of this fourth conversion function.

2. The method according to claim 1, wherein the selected suction time is at least 0.1 seconds.

3. The method according to claim 1, wherein the half-width of the distribution function of the particle sizes around its mean particle diameter is determined based on the established mean particle diameter and a constant factor, and the number of particles is determined based on the characteristic value, the established mean diameter and the value for the half-width.

4. The method according to claim 1, wherein a plurality of measurements is taken in succession, the detected quantities of particles are added up and/or integrated according to their respective suction times, suction volumes and/or suction lengths, and the integral number of particles is determined from these weighted added up values.

5. The method according to claim 1, wherein a total test volume is determined in addition to the indicated characteristics, in that the volume flows that are proportional to the predetermined weighting factors are collected, and the quantity and the number of particles is established based thereupon, and, taking into account the relationship between the respective suction volume and the total test volume, the integral quantity and number of particles are determined, wherein the volume flow of the exhaust gas that is aspirated over the filter paper of the measuring instrument is adjusted or controlled proportionally relative to the weighting factor, and the exhaust gas volume that corresponds to this weighting factor is aspirated over this filter paper.

6. The method according to claim 1, wherein a plurality of measurements is taken in succession, the quantity and number of particles is detected for each measurement, and a mean value and the associated imprecision and/or uncertainty of the measurement is/are calculated.

7. The method according to claim 1, wherein the exhaust gas temperature at the sampling point and/or the mean dwelling time of the exhaust gas from the generation point of the particles to the sampling point are taken into account for the calculation.

8. The method according to claim 1, wherein the second conversion function characterizes, in a dual-logarithmic presentation and in the range of very few up to ca. 10¹⁴ particles per test, a linear relationship between the mass and the number of the particles that changes over to an inverse function with the further increase of the number of particles.

9. The method according to claim 8, wherein the second conversion function has a peak at a number of ca. 2 to 5×10¹⁴ particles per test.

10. The method according to claim 2, wherein the selected suction time is at least 1 second.
